(19) United States
(12) Patent Application Publication
(10) Pub. No.: US 2011/0222099 A1
(43) Pub. Date: Sep. 15, 2011

(54) VERIFICATION APPARATUS, JOB TICKET VERIFICATION METHOD, AND COMPUTER-READABLE MEDIUM

(75) Inventor: Namihiro Mori, Kawasaki-shi (JP)

(73) Assignee: CANON KABUSHIKI KAISHA, Tokyo (JP)

(21) Appl. No.: 13/026,201

(22) Filed: Feb. 11, 2011

(30) Foreign Application Priority Data
Mar. 12, 2010 (JP) 2010-056539

(51) Int. Cl. G06K 15/02

(52) U.S. Cl. 358/1.14

(57) ABSTRACT

An apparatus for verifying whether or not processing of a received job ticket is feasible in a printing apparatus, comprises: a unit which holds capability information associated with capabilities included in the printing apparatus and verification information associated with verification items respectively for the capabilities; a unit which generates, based on user identification information, which is defined for each user who designates execution of the processing of the job ticket and indicates available functions in the printing apparatus and verification items for the user, and the capability information, printer capability data indicating feasible capabilities of the user in the printing apparatus; a unit which generates verification policy data indicating feasible verification items of the user for the job ticket; and a unit which verifies based on the printer capability data and the verification policy data whether or not the processing of the job ticket is feasible in the printing apparatus.

### BACKGROUND OF THE INVENTION

1. Field of the Invention

The present invention relates to a verification apparatus which verifies feasibility of a print workflow designated by a job ticket, a job ticket verification method, and a computer-readable medium.

2. Description of the Related Art

In a workflow system which manages print and publishing processes, a method using a JDF (Job Definition Format) as a job ticket having a standardized format has been proposed as a method of executing print processing using digital documents.

In a printing system using this JDF, since there remains concern that a plurality of user systems send print jobs which have different contents and are not based on specifications to printers, unintended results for users may be output. Hence, a job ticket has to be verified before execution of print processing to check if a workflow designated by the job ticket is feasible.

As a verification example of the job ticket, a method of executing the test operation of the workflow, stopping the test when a problem is posed in the middle of the test, notifying the user of the problem contents, re-setting parameters, and restarting the test has been proposed (Japanese Patent Laid-Open No. 2008-278071).

Also, a method of embedding an encoded print workflow in metadata in a job ticket, and comparing and collating it with an encoded workflow which is held in advance to discriminate validity of the workflow has been proposed (Japanese Patent Laid-Open No. 2008-015917).

However, with the aforementioned conventional techniques, the verification contents for job tickets cannot be changed in accordance with user systems as sending sources of the job tickets. Hence, a case in which functions available for the printer and verification contents to be changed according to users cannot be coped with. Furthermore, verifications corresponding to printer functions cannot be made in accordance with connection information and capability information of the printer.

### SUMMARY OF THE INVENTION

In order to solve the aforementioned problems, a verification as to whether or not a workflow designated by a job ticket is feasible for a target user and target printer has to be allowed before sending the job ticket.

According to one aspect of the present invention, there is provided a verification apparatus for verifying whether or not processing of a received job ticket is feasible in a printing apparatus, the apparatus comprising: a holding unit which holds capability information associated with capabilities included in the printing apparatus and verification information associated with verification items respectively for the capabilities; a printer capability data generation unit which generates, based on user identification information, which is defined for each user who designates execution of the processing of the job ticket and indicates available functions in the printing apparatus and verification items for the user, and the capability information, printer capability data indicating feasible capabilities of the user in the printing apparatus; a verification policy generation unit which generates verification policy data indicating feasible verification items of the user for the job ticket based on the user identification information and the verification information; and a verification unit which verifies based on the printer capability data and the verification policy data whether or not the processing of the job ticket is feasible in the printing apparatus.

According to the present invention, whether or not a workflow designated by a job ticket is feasible can be verified before the job ticket is sent to the target printer. Furthermore, the verification contents can be dynamically changed according to user system or printer information.

Further features of the present invention will become apparent from the following description of exemplary embodiments (with reference to the attached drawings).

### BRIEF DESCRIPTION OF THE DRAWINGS

FIG. 1 is a block diagram showing the arrangement of a printing system according to an embodiment of the present invention;

FIG. 2 is a block diagram showing the internal arrangement of an information processing apparatus according to the embodiment;

FIG. 3 is a diagram showing an example of the concept of workflow execution according to the embodiment;

FIGS. 4A and 4B are exemplary views of the concept and practical data structure of a job ticket according to the embodiment;

FIGS. 5A and 5B are exemplary views of the concept and practical data structure of printer capability data according to the embodiment;

FIG. 6 is an exemplary view of the structure of verification policy data according to the embodiment;

FIG. 7 is an exemplary view of a database structure of user data according to the embodiment;

FIG. 8 is a flowchart showing job ticket verification processing of the information processing apparatus according to the first embodiment;

FIG. 9 is a flowchart showing printer capability data generation processing of a printer capability generation unit according to the first embodiment;

FIG. 10 is a flowchart showing verification policy data generation processing of a verification policy generation unit according to the first embodiment;

FIG. 11 is a flowchart showing job ticket verification processing of a verification engine according to the first embodiment; and

FIG. 12 is a flowchart showing job ticket verification processing of an information processing apparatus according to the second embodiment.

### DESCRIPTION OF THE EMBODIMENTS

### First Embodiment

[System Arrangement]

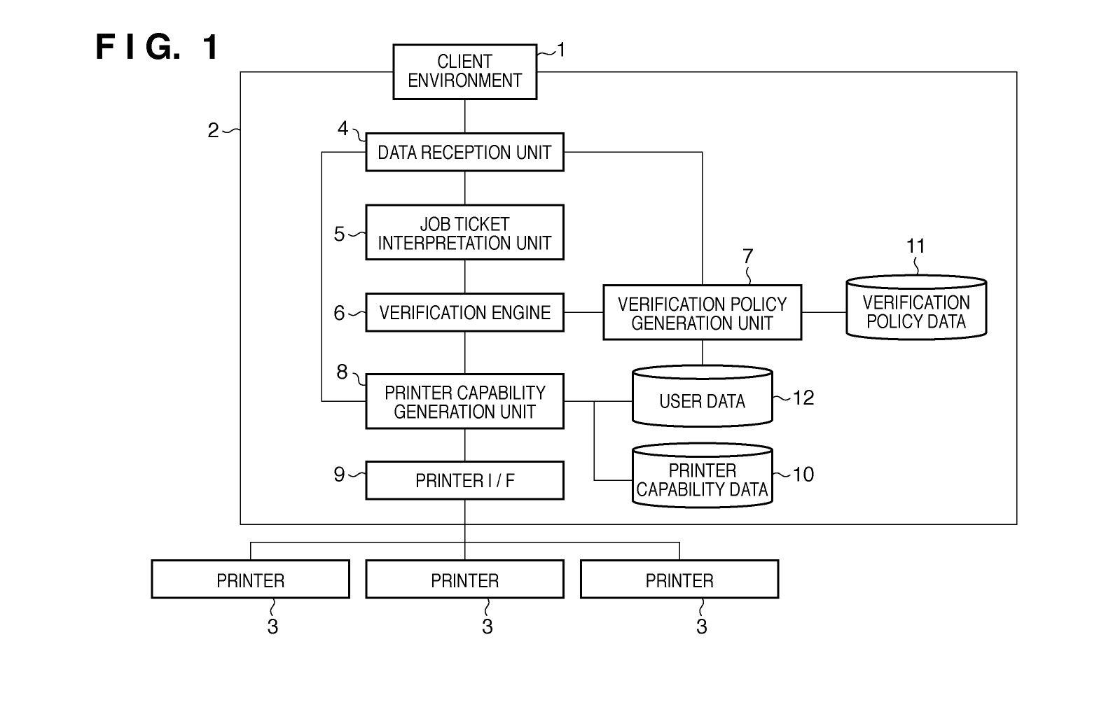

Embodiments for carrying out the present invention will be described hereinafter with reference to the drawings. FIG. 1 is a block diagram showing the arrangement of a printing system according to the present invention. This system is roughly configured by a client environment 1, information processing apparatus 2, and printers 3. The client environment 1 mainly generates a job ticket and content information, and sends a print job to the information processing apparatus 2. The client environment 1 is connected to the information processing apparatus 2 via a network, and communicates with it via a predetermined medium such as the Internet. Alternatively, the client environment 1 may be included in the information processing apparatus 2. Note that the first embodiment will exemplify a case in which the client environment 1 is included in the information processing apparatus 2, and the second embodiment will exemplify a case in which the client environment 1 and information processing apparatus 2 are connected via the network. The information processing apparatus 2 verifies a job ticket. The information processing apparatus 2 includes a data reception unit 4, job ticket interpretation unit 5, verification engine 6, verification policy generation unit 7, printer capability generation unit 8, and printer I/F 9. Each printer 3 is a printing apparatus which interprets a print job sent via the printer I/F 9, and rasterizes and prints an image.

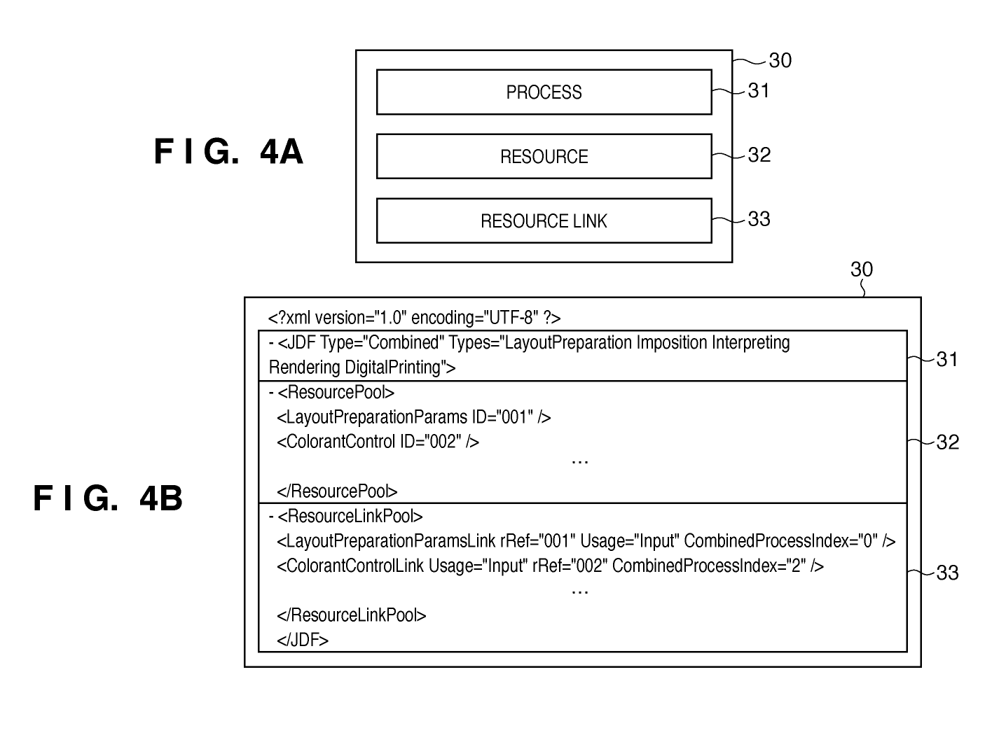

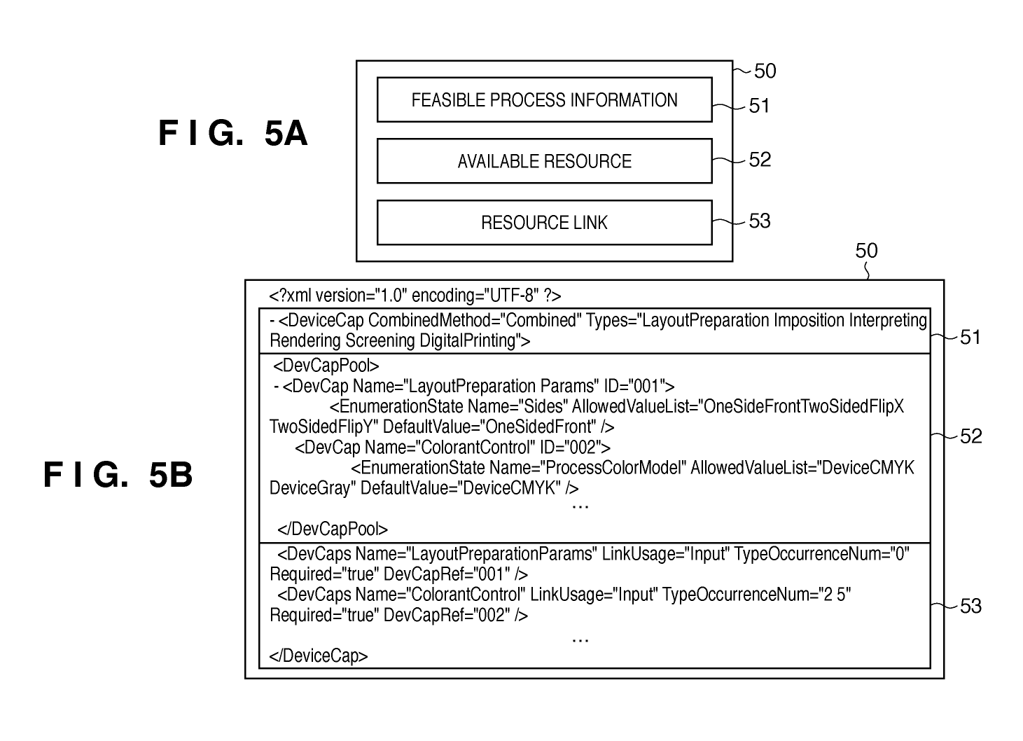

The data reception unit 4 receives data such as a print job and user information (for example, a user ID) from the client environment 1. The job ticket interpretation unit 5 has the function of interpreting a job ticket received via the data reception unit 4. The job ticket interpretation unit 5 interprets the job ticket, and saves information associated with print settings for content information in a memory. The verification engine 6 is a mechanism which compares and collates capability information of each printer 3 as a target that executes a workflow with the job ticket, and determines based on verification policy data whether or not the workflow of the job ticket is feasible by the target printer 3. Note that the capability information indicates, for example, feasible functions of the printer. The verification policy generation unit 7 has the function of generating verification policy data used as a policy upon verifying the job ticket. The practical structure of the verification policy data will be described later with reference to FIGS. 5A and 5B. The printer capability generation unit 8 generates printer capability data based on the printer capability information and the user ID of the client environment, which are acquired via the printer I/F 9. Note that the practical structure of the printer capability data will be described later with reference to FIGS. 4A and 4B. The printer I/F 9 is an interface used to control communications with the printers 3. The printer I/F 9 has the function of acquiring capability information, configuration information, and printer connection information from the printers 3, and the function of sending a print job to the printers 3.

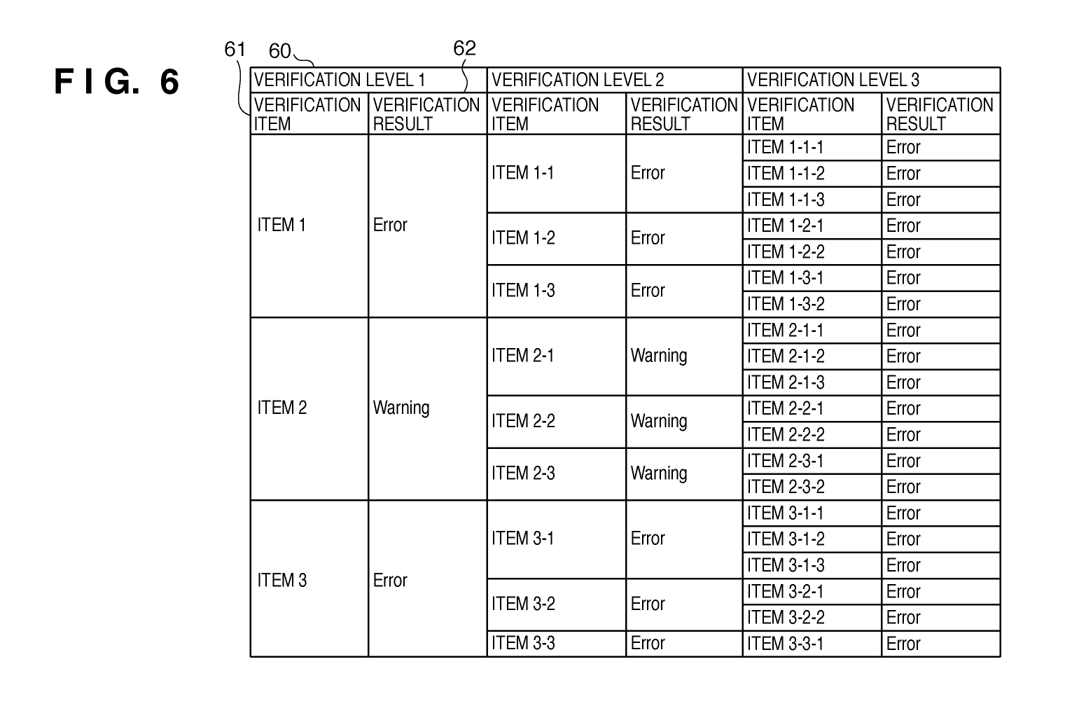

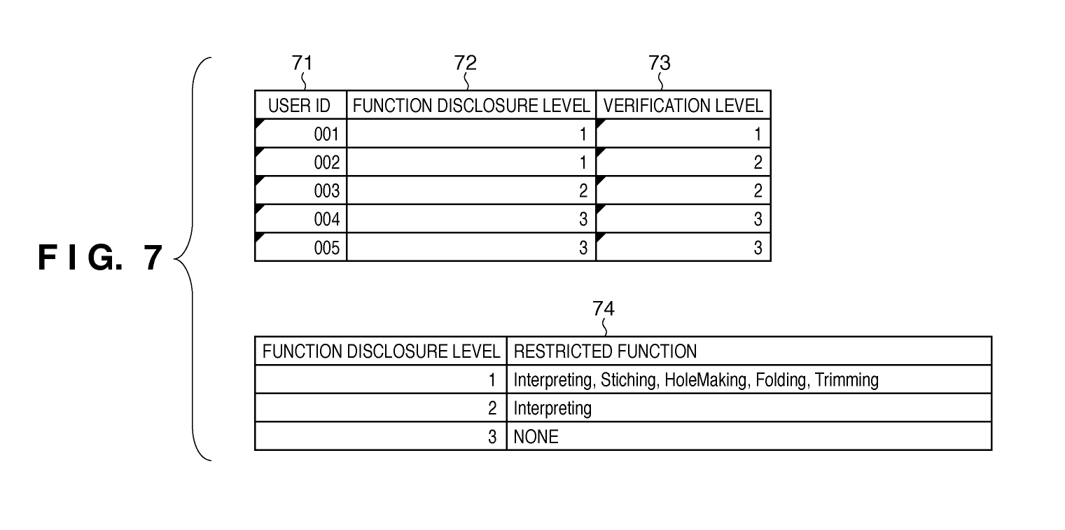

The information processing apparatus 2 holds three data, that is, printer capability data 10, verification policy data 11, and user data 12. The printer capability data 10 will be described in detail later with reference to FIGS. 5A and 5B, the verification policy data will be described in detail later with reference to FIG. 6, and the user data will be described in detail later with reference to FIG. 7.

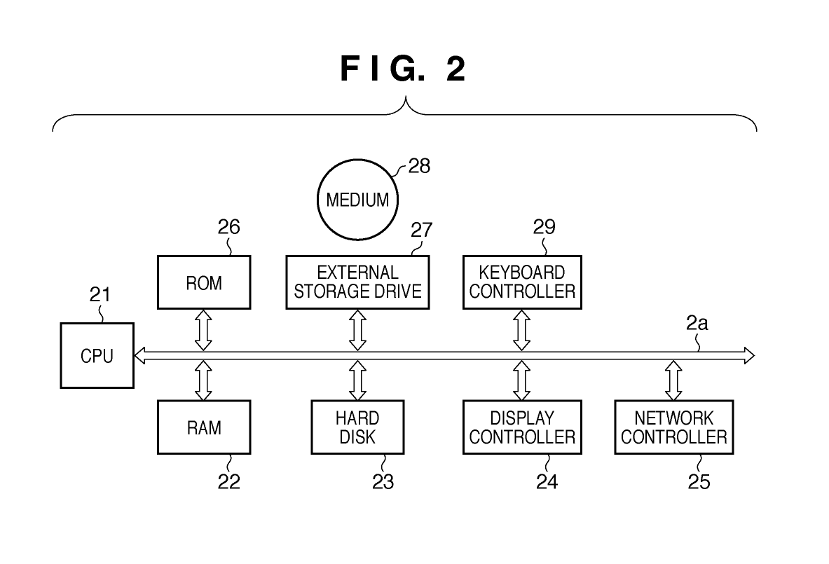

FIG. 2 is a block diagram showing the internal arrangement of the information processing apparatus 2. A CPU 21 executes programs stored in a program area assured in a ROM 26, or programs such as an OS and general-purpose applications, which are loaded from a hard disk 23 onto a RAM 22. The RAM 22 serves as, for example, a main memory and work area of the CPU 21. The hard disk 23 stores, for example, a boot program, various applications, font data, user files, and digital document files. All of print jobs received by the information processing apparatus 2 and those generated by a job generation application included in the information processing apparatus 2 are sent to the hard disk 23. A display controller 24 controls display processing on a display. A network controller 25 executes communication control processing with other devices connected to a network. A keyboard controller 29 controls key inputs from a keyboard and pointing device. The CPU 21 is connected to the respective blocks via an internal bus 2a. The information processing apparatus 2 includes an external storage drive 27, and the CPU 21 can acquire information from a medium 28 as a portable medium. Note that the arrangement of the information processing apparatus 2 is not limited to that shown in FIG. 2 as long as functions as a general information processing apparatus need only be implemented.

[Workflow]

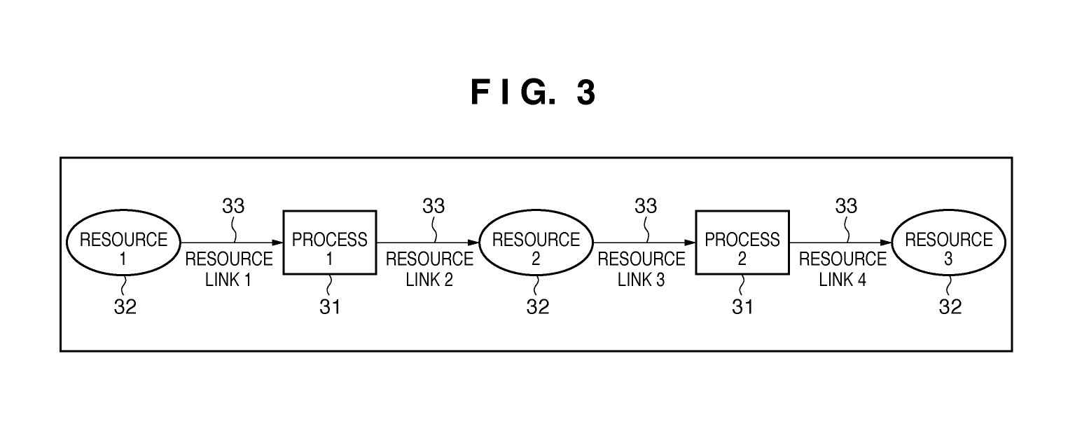

FIG. 3 is a diagram showing an example of the concept of workflow execution. A workflow is configured by one or more processes 31, resources 32, and resource links 33, and the processes 31 are executed according to a designated order. Each process 31 represents one unit of processing such as “printing” or “trimming”. Each resource 32 represents parameters which are to be input to or output from the corresponding process 31. The resource 32 includes, for example, numerical parameters such as “imposition parameters”, and physical parameters such as “printed product”. Each resource link 33 is information which associates the process 31 with the resource 32. In this case, resource link 1 represents that resource 1 is an input to process 1, and resource link 2 represents that resource 2 is an output from process 1.

[Job Ticket]

FIGS. 4A and 4B are views showing an example of the concept of a data structure and a practical data structure of a job ticket. A job ticket 30 shown in FIG. 4A expresses a workflow which is to be executed based on three pieces of information including the process 31, resource 32, and resource link 33 described in FIG. 3. The process 31 represents information associated with the contents of respective processes and their order in the workflow to be executed. More specifically, the designated workflow intends to continuously execute respective processes described in a Types attribute in FIG. 4B in turn. The resource 32 represents information associated with parameters which are input to or output from the respective processes. More specifically, the resource 32 represents that two resources “LayoutPreparationParams” and “ColorantControl” in FIG. 4B are related to the processes 31 included in the workflow. The resource link 33 indicates the input/output relationship between the resources 32 and processes. More specifically, a resource link “LayoutPreparationParamsLink” in FIG. 4B indicates that the resource “LayoutPreparationParams” is an input to a process “LayoutPreparation”. Also, a resource link “ColorantControlLink” indicates that the resource “ColorantControl” is an input to a process “Interpreting”.

[Data Structure (Printer Capability)]

FIGS. 5A and 5B are views showing an example of the concept of a data structure and a practical data structure of the printer capability data 10. Printer capability data 50 shown in FIG. 5A expresses a feasible workflow of the printer using three pieces of information, that is, a feasible process 51, available resource 52, and resource link 53. The feasible process 51 represents the contents of feasible processes of the target printer, and their order. More specifically, the feasible process 51 indicates that processes described in a Types attribute in FIG. 5B are feasible in an order described in FIG. 5B. Also, the feasible process 51 indicates based on a CombinedMethod attribute that a plurality of processes is continuously feasible in a single printer.

The available resource 52 represents information associated with resources to be input to or output from the respective feasible resources. In case of FIG. 5B, the available resource 52 represents that two resources “LayoutPreparationParams” and “ColorantControl” can be input to or output from the feasible processes 51. Also, as can be seen from FIG. 5B, “Sides” as a print setting item included in the resource “LayoutPreparationParams” allows to set one of “OneSidedFront”, “TwoSidedFlipX”, and “TwoSidedFlipY”. Furthermore, as can be seen from FIG. 5B, “ProcessColorModel” as a print setting item included in the resource “ColorantControl” allows to set one of “DeviceCMYK” and “DeviceGray”.

The resource link 53 indicates the input/output relationship between the resources 52 and feasible processes 51. In case of FIG. 5B, the resource link 53 indicates that the resource “LayoutPreparationParams” can be input to the process “LayoutPreparation”. Also, the resource link 53 indicates that the resource “ColorantControl” can be input to the process “Interpreting”.

[Data Structure (Verification Policy)]

FIG. 6 is a table showing an example of the structure of the verification policy data 11 as verification information. The verification policy data 11 classifies verification items 61 and verification results 62 of a job ticket in a hierarchical structure. As the verification level 60 becomes higher (that is, toward the right side of the table shown in FIG. 6), detailed verification conditions appear. The verification items 61 include contents as to what kind of verification is to be made. For example, the verification items 61 include contents such as “whether or not an order of processes in a job ticket is proper” and “whether or not resources input and output to a given process are proper”. The verification results 62 indicate responses when verification conditions are not satisfied. For example, in a certain verification policy, when a verification result for an arbitrary verification item is defined as “Error”, if a verification condition is not satisfied, a job ticket is considered as invalid (that is, Error). When a verification result for an arbitrary verification item is defined as “Warning”, if a verification condition is not satisfied, a job ticket is not considered as invalid but a warning is output (that is, Warning).

[Data Structure (User Data)]

FIG. 7 is a view showing an example of the database structure of the user data 12. Assume that a user ID 71, function disclosure level 72, and verification level 73 are registered in the user data 12 before the system is started up. The user ID 71 represents an identifier of the user designated for each client environment. The function disclosure level 72 represents a level required to set an upper limit function of the printer that the user of the client environment 1 is permitted to use. The verification level 73 represents a level of verification to be made for the user of the client environment 1. A restricted function 74 represents unavailable functions (restricted functions) of the printer in correspondence with a certain function disclosure level. For example, the function disclosure level 72 of a user whose user ID 71 is “001” is “1”. Hence, the user “001” cannot use any of five functions “Interpreting”, “Stitching”, “HoleMaking”, “Folding”, and “Trimming” included in the restricted function 74 even when a certain printer 3 has these functions. Likewise, since the function disclosure level 72 of a user whose user ID 71 is “003” is “2”, the user “003” can use functions other than “Interpreting”. However, since the verification level 73 of the user “003” is “2”, verification items of the verification policy shown in FIG. 6 up to a verification level 2 can only be verified. That is, the user data defines, for example, available printer functions and verification items for each user.

[Job Ticket Verification Processing]

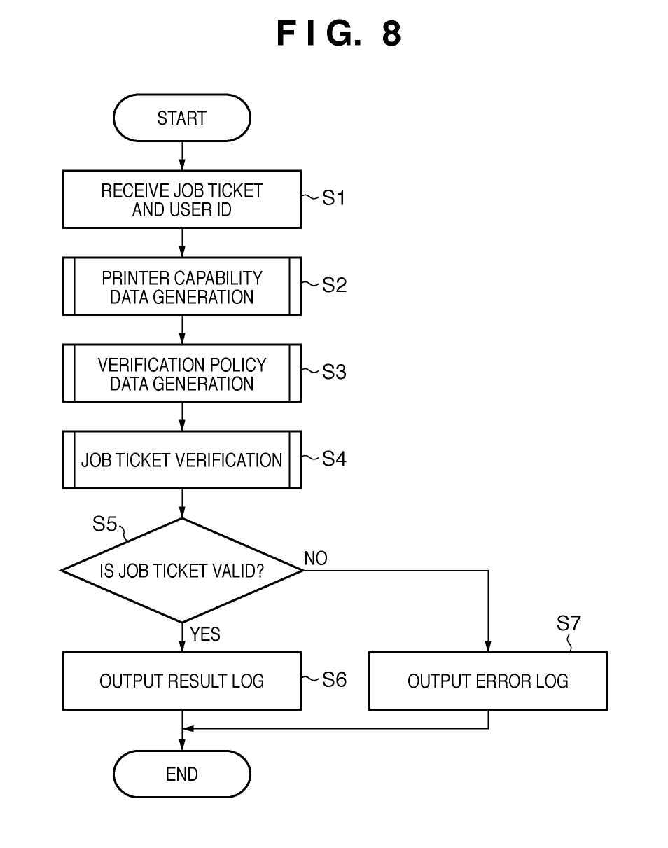

FIG. 8 is a flowchart showing an example of job ticket verification processing to be executed by the information processing apparatus 2 according to the first embodiment. A program associated with this sequence is stored in the hard disk 23 of the information processing apparatus 2, and is read out onto the RAM 22 when that program is executed by the CPU 21. In this sequence, a verification example of a job ticket generated by the client environment 1 included in the information processing apparatus 2 will be explained.

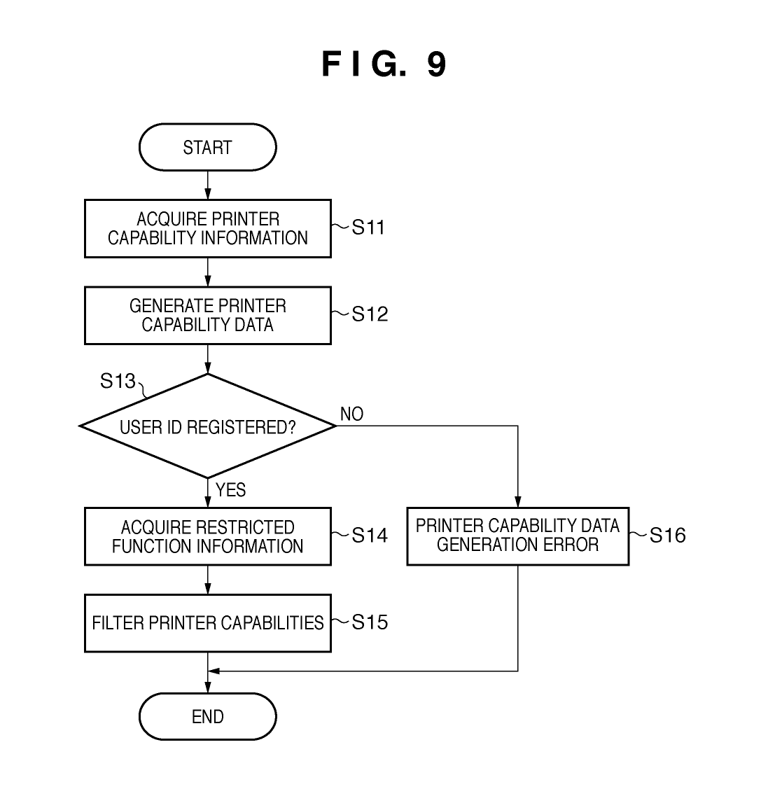

In step S1, the data reception unit 4 receives a job ticket and user ID from a print job sent from the client environment 1. As the user ID, the user ID 71 registered in advance in the information processing apparatus 2 has to be designated, and is used in subsequent steps. In step S2, the printer capability generation unit 8 generates the printer capability data 10. The printer capability data 10 is used to be compared and collated with the job ticket upon verification of the job ticket. This step will be described in detail later with reference to FIG. 9.

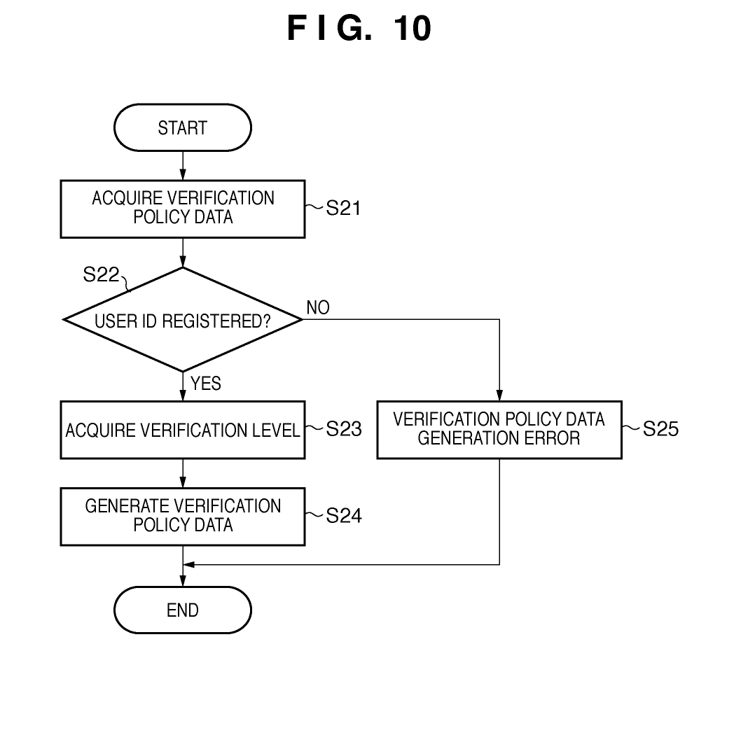

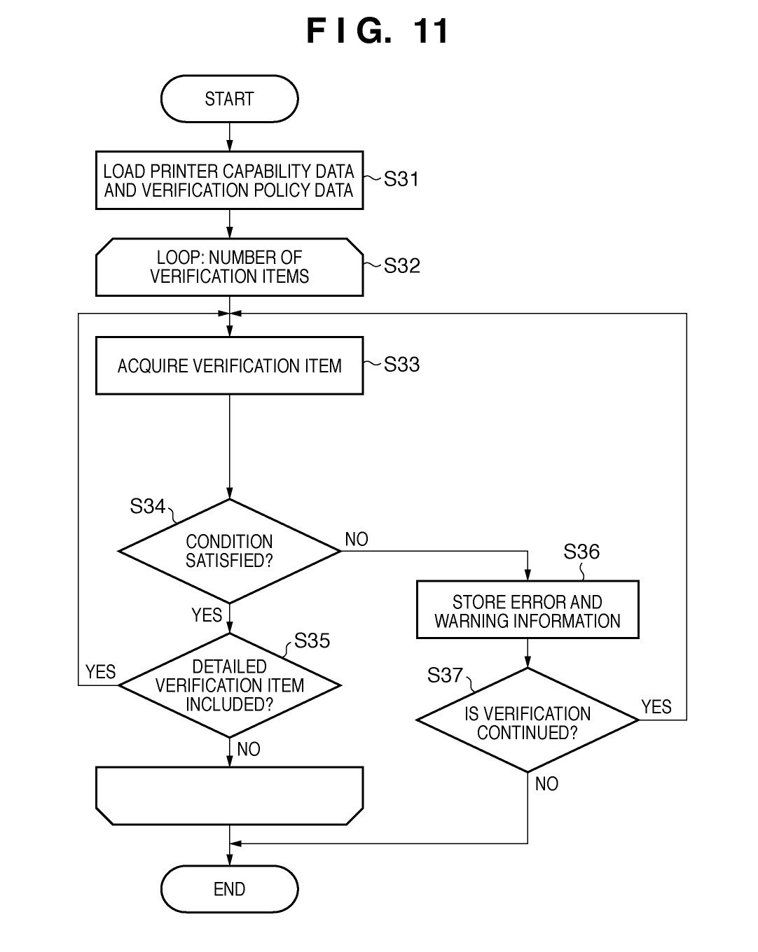

In step S3, the verification policy generation unit 7 generates verification policy data based on the designated user ID. The verification policy data 11 is used to decide items to be verified of the job ticket. This step will be described in detail later with reference to FIG. 10. After the printer capability data 10 and verification policy data 11 are generated, the verification engine 6 verifies the job ticket in step S4. Practical verification contents include, for example, verifications as to whether or not a workflow is intended to be executed by the single printer 3, whether or not the processes 31 have correct contents and order, whether or not the input/output relationship between the resources 32 and resource links 33 is correct, and whether or not the contents of the resources 32 are correct. This step will be described in detail later with reference to FIG. 11.

After the job ticket is verified, if it is determined in step S5 that the job ticket verified in step S4 is valid (YES in step S5), the process advances to step S6. If it is determined in step S5 that the job ticket is not valid (NO in step S5), the process advances to step S7. Assume that the validity of the job ticket is determined based on the verification processing executed in step S4, and may be determined based on, for example, the presence/absence of an error result and the number of output warnings. In step S6, a result log indicating that the job ticket is valid is output, thus ending the processing. In step S7, an error log indicating that the job ticket is not valid for certain verification contents is output, thus ending the processing. Note that the processes in step S2 and S3 may be executed in the reverse order.

[Printer Capability Data Generation]

FIG. 9 is a flowchart showing an example of generation processing of the printer capability data 10 executed by the printer capability generation unit 8 according to the first embodiment.

In step S11, the printer capability generation unit 8 acquires capability information from the printers 3 connected to the information processing apparatus 2 via the printer I/F 9. Note that the capability information acquired in this step is not limited to that acquired from the connected printer, but it may be acquired from an apparatus which manages capability information. In step S12, the printer capability generation unit 8 generates the printer capability data 10 based on the printer capability information acquired in step S11. The printer capability data 10 has the structure shown in FIGS. 5A and 5B. After the printer capability data 10 is generated, the printer capability generation unit 8 discriminates in step S13 whether or not the user ID of the user who uses the client environment 1 is registered in the user data 12. If the user ID is registered (YES in step S13), the process advances to step S14; if the user ID is not registered or it is not loaded (NO in step S13), the process advances to step S16 to return an error. Then, this processing sequence ends.

In step S14, the printer capability generation unit 8 acquires the restricted functions 74 based on the function disclosure level 72 corresponding to the user ID 71 in the user data 12. As a result, information of the printer available for the designated user ID can be acquired. Next, in step S15 the printer capability generation unit 8 deletes information associated with processes included in the restricted functions 74 of the feasible processes 51, available resources 52, and resource links 53 in the printer capability data generated in step S12. Thus, printer capability information corresponding to the function disclosure and verification levels held in correspondence with the user ID is generated. After that, this processing sequence ends.

[Verification Policy Data Generation]

FIG. 10 is a flowchart showing an example of generation processing of the verification policy data 11 for each user executed by the verification policy generation unit 7 according to the first embodiment.

In step S21, the verification policy generation unit 7 acquires the verification policy data 11. The verification policy data 11 is held in advance by the verification policy generation unit 7, and has the structure shown in FIG. 6. Next, the verification policy generation unit 7 determines in step S22 whether or not the user ID of the user who uses the client environment 1 is registered in the user data 12. If the user ID is registered (YES in step S22), the process advances to step S23; if the user ID is not registered or it is not loaded (NO in step S22), the process advances to step S25. In step S25, a verification policy data generation error is returned, and this processing sequence ends. In step S23, the verification policy generation unit 7 acquires the verification level 73 corresponding to the user ID 71 in the user data 12. With this information, items that a certain user can verify can be known. Finally, in step S24 verification policy data for the user who designated the job ticket is generated based on the verification level acquired in step S23.

[Job Ticket Verification]

FIG. 11 is a flowchart showing an example of job ticket verification processing executed by the verification engine 6 according to the first embodiment.

In step S31, the verification engine 6 loads the printer capability data 10 generated by the printer capability generation unit 8 and the verification policy data 11 generated by the verification policy generation unit 7. In step S32, the verification engine 6 performs verifications along the verification items 61 included in the verification policy data 11. The subsequent processing is repeated as many as the number of verification items 61 included in the verification policy data 11.

In step S33, the verification engine 6 acquires one verification item 61. Then, the verification engine 6 calls a processing function (to be referred to as a verification function hereinafter) which is included itself in the verification engine 6 and is required to perform a verification corresponding to the acquired verification item 61, and performs the verification. In step S34, the verification engine 6 collates the job ticket with the printer capability data 10 to determine whether or not the verification performed using the verification function satisfies a condition. If the verification satisfies the condition (YES in step S34), the process advances to step S35; otherwise (NO in step S34), the process advances to step S36.

The verification engine 6 determines in step S35 whether or not the verification item 61 that satisfies the condition includes a further detailed verification item. If the verification item 61 includes a further detailed verification item (YES in step S35), the process returns to step S33 to perform a verification in association with the detailed verification item. If the verification item 61 does not include any further detailed verification item (NO in step S35), the process returns to step S32 to perform a verification for the next verification item. When all the verification items 61 included in the verification policy data 11 have been verified, this sequence ends. In step S36, the verification engine 6 stores verification result information such as error information and warning information based on the definitions of processing to be executed when the conditions are not satisfied. After that, the verification engine 6 determines in step S37 whether or not to continue verifications. If the verifications are to be continued (YES in step S37), the process returns to step S33; otherwise (NO in step S37), the verification processing ends.

As described above, whether or not a print workflow expressed in a job ticket is valid (that is, whether or not the workflow is feasible or whether or not there is an item to give a warning to the user) can be verified. Also, the verification processing can be easily performed while dynamically changing the verification contents according to the user who uses the user system, and capability information and connection information of the printer.

### Second Embodiment

The first embodiment has exemplified the case in which the client environment 1 is included in the information processing apparatus 2. As shown in FIG. 8, after the user designates the user ID upon sending a job ticket in step S1, when the user ID is not registered in the user data 12 in the information processing apparatus 2 in steps S2 and S3, an error is returned. The second embodiment will exemplify a case in which the client environment 1 and information processing apparatus 2 are connected via a network. The client environment in this case assumes, for example, a client terminal represented by an information processing apparatus such as a PC. This embodiment will assume a case in which a verification system included in the information processing apparatus 2 makes communications via a Web such as a Web application, and will exemplify verification processing executed when authentication information required for the user in login processing to the Web application is handled as user data 12. Note that when this embodiment is implemented using the Web application, for example, HTTP or HTTPS can be used as a communication protocol.

[Job Ticket Verification Processing]

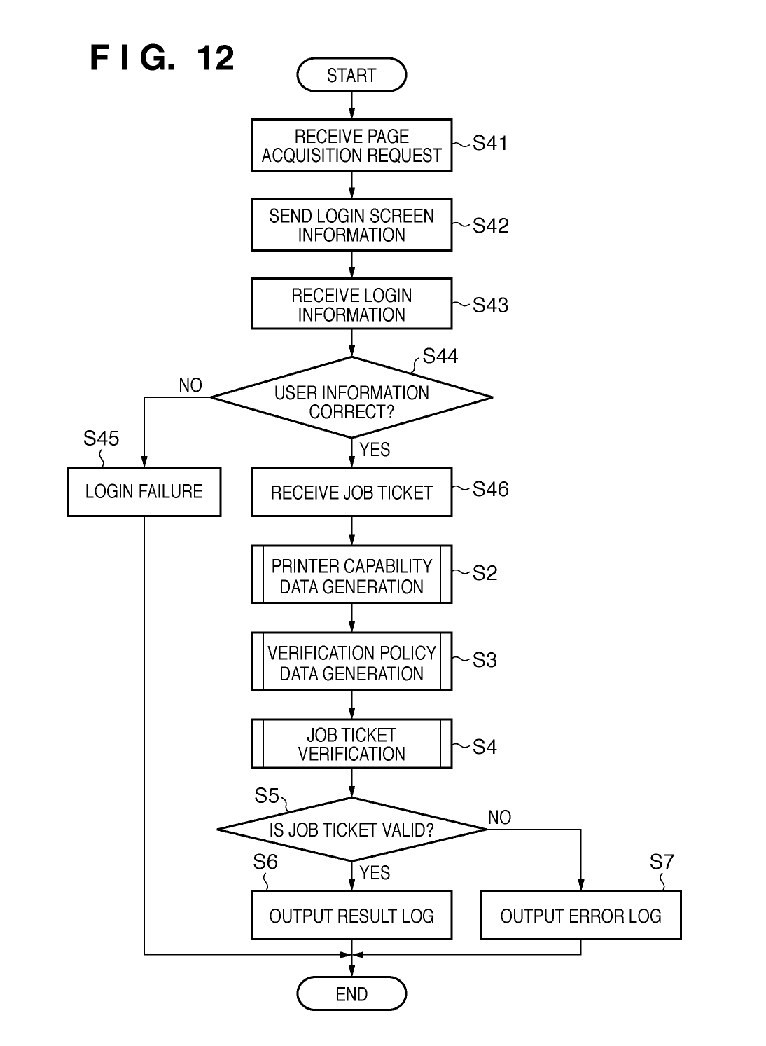

FIG. 12 is a flowchart showing an example of job ticket verification processing executed by the information processing apparatus 2 according to the second embodiment. FIG. 12 corresponds to FIG. 8 described in the first embodiment.

In step S41, a data reception unit 4 receives a page acquisition request from the client environment 1. In step S42, login screen information is sent to the client environment 1. The user displays this login screen information using, for example, a Web browser of the client environment 1, and executes login processing. If the user has done the login processing, the data reception unit 4 receives user information input from the user at the time of the login processing in step S43. Thus, user information reception is implemented.

The data reception unit 4 determines in step S44 whether or not a user ID included in the user information received in step S43 is registered in the user data 12. If the user ID is not registered (NO in step S44), the process advances to step S45 to send a login failure message to the client environment 1. Then, this processing sequence ends. If the user ID is registered (YES in step S44), the process advances to step S46 to receive a job ticket from the client environment 1. In this way, job ticket reception is implemented. Since processes after the job ticket reception in step S46 are the same as those after step S2 in FIG. 8, a description thereof will not be repeated. Note that the processes in step S13 in FIG. 9 and step S22 in FIG. 10 need not be executed since whether or not the user ID is registered in the user data is confirmed in the login processing.

As described above, the present invention is applicable by using authentication information at the time of application login processing as user identification information. That is, even in the environment in which the client environment 1 and information processing apparatus 2 are connected via the network, the verification system according to the present invention can be easily used without installing any new software on the client environment side. Also, as in the first embodiment, the verification processing can be easily performed while dynamically changing the verification contents according to the user who uses the user system, and capability information and connection information of the printer.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-056539, filed Mar. 12, 2010, which is hereby incorporated by reference herein in its entirety.

What is claimed is:

1. A verification apparatus for verifying whether or not processing of a received job ticket is feasible in a printing apparatus, said apparatus comprising:
a holding unit which holds capability information associated with capabilities included in the printing apparatus and verification information associated with verification items respectively for the capabilities;
a printer capability data generation unit which generates, based on user identification information, which is defined for each user who designates execution of the processing of the job ticket and indicates available functions in the printing apparatus and verification items for the user, and the capability information, printer capability data indicating feasible capabilities of the user in the printing apparatus;
a verification policy generation unit which generates verification policy data indicating feasible verification items of the user for the job ticket based on the user identification information and the verification information; and
a verification unit which verifies based on the printer capability data and the verification policy data whether or not the processing of the job ticket is feasible in the printing apparatus.

2. The apparatus according to claim 1, further comprising a reception unit which receives the user identification information together with the job ticket from a client terminal which sends the job ticket.

3. The apparatus according to claim 1, wherein the printer capability data is generated according to capability information and connection information of a printing apparatus as a target that executes a print workflow designated by the job ticket.

4. The apparatus according to claim 1, wherein the printer capability data is defined by restricting functions for the job ticket according to the user identification information.

5. The apparatus according to claim 1, wherein the verification policy includes at least one of a verification as to whether or not a workflow designated by the job ticket is designated to be executed by a single printing apparatus, a verification as to whether or not processes included in the workflow have contents or an order suited to the printing apparatus, and a verification as to whether parameters to be input to or output from processes have values suited to processing for the printing apparatus.

6. The apparatus according to claim 1, wherein the verification policy data is generated to define verifications in functions for the job ticket, which are to be executed using verification items of different detailed levels, in accordance with the user identification information.

7. The apparatus according to claim 1, further comprising:
a user information reception unit which sends, when a request for processing of a job ticket is received from a client terminal, login screen information used to input user information to the client terminal, and accepts the user information; and
a job ticket reception unit which accepts, when user identification information included in the accepted user information is registered, an input of the job ticket.

8. A verification method of verifying whether or not processing of a received job ticket is feasible in a printing apparatus, the method comprising:
a printer capability data generation step of controlling a printer capability data generation unit to generate, based on user identification information, which is defined for each user who designates execution of the processing of the job ticket and indicates available functions in the printing apparatus and verification items for the user, and capability information associated with capabilities included in the printing apparatus, printer capability data indicating feasible capabilities of the user in the printing apparatus;
a verification policy generation step of controlling a verification policy generation unit to generate verification policy data indicating feasible verification items of the user for the job ticket based on the user identification information and verification information associated with verification items respectively for the capabilities; and
a verification step of controlling a verification unit to verify based on the printer capability data and the verification policy data whether or not the processing of the job ticket is feasible in the printing apparatus.

9. A computer-readable medium storing a program for controlling a computer to function as:
a printer capability data generation unit which generates, based on user identification information, which is defined for each user who designates execution of processing of a job ticket and indicates available functions in the printing apparatus and verification items for the user, and capability information associated with capabilities included in the printing apparatus, printer capability data indicating feasible capabilities of the user in the printing apparatus;
a verification policy generation unit which generates verification policy data indicating feasible verification items of the user for the job ticket based on the user identification information and verification information associated with verification items respectively for the capabilities; and
a verification unit which verifies based on the printer capability data and the verification policy data whether or not the processing of the job ticket is feasible in the printing apparatus.
